(19) United States
(12) Patent Application Publication
(10) Pub. No.: US 2012/0016554 A1
(43) Pub. Date: Jan. 19, 2012

(54) VEHICLE INFORMATION UNIFICATION METHOD WHICH COMBINES WITH A HAND-HELD ELECTRONIC DEVICE

(76) Inventor: Chun-Jung HUANG, Tainan City (TW)

(21) Appl. No.: 13/182,785

(22) Filed: Jul. 14, 2011

(30) Foreign Application Priority Data
Jul. 15, 2010 (TW) 099123325

(51) Int. Cl. G06F 17/00; G07B 15/00; G06F 13/14; G06Q 40/00

(52) U.S. Cl. 701/36; 705/39; 705/13; 710/15

(57) ABSTRACT

In a vehicle information unification method which combines with a hand-held electronic device, a hand-held electronic device, which includes a first processor, a first screen and a first transmission interface, is connected with a receiving system of a vehicle. The hand-held electronic device and the receiving system are interconnected within an effective distance through the first transmission interface and a second transmission interface of the receiving system, allowing the receiving system to access digital messages in a storage unit of the hand-held electronic device. The digital messages are computed and a result of computation is outputted for use by the vehicle. By the interconnection between the hand-held electronic device and the receiving system of the vehicle, the vehicle can access and apply information of various hand-held electronic devices to provide the vehicle information that is personalized, convenient and safe.

### BACKGROUND OF THE INVENTION

a) Field of the Invention

The present invention relates to a vehicle information unification method which combines with a hand-held electronic device, and more particularly to a vehicle information unification method which utilizes an interconnection of a hand-held electronic device with a vehicle receiving system to allow the vehicle to access and apply information of various hand-held electronic devices, thereby providing a personalized, convenient and safe unification method of the vehicle information.

b) Description of the Prior Art

In recent years, the smart phones have already replaced the conventional cell phones and the efficiency of the existing smart phone has already exceeded that of a desktop XT or AT286 computer in 1980s, only inferior to a laptop computer. Therefore, the smart phone is called a palmtop computer.

Until now, the manufacturers of smart phones are mostly focusing their R&D on the conventional calling and entertaining functions; whereas, they are only limited to data synchronization in terms of combining the smart phones with the desktop and laptop computers, where the data on the smart phone are backed up to the desktop or laptop computer and the data on the desktop and laptop computer, such as E-mails, calendars, contact information or notes, are copied onto the smart phone. This allows a user to read e-mails or other related data in any time and at any place. The smart phone also provides for navigation and multimedia functions, such as an MP3 (Moving Picture Experts Group Layer-3 Audio) (only accessing the third audio layer of MPEG-3) or MP4 (Moving Picture Experts Group Layer-4), a network digital TV program or video game.

The audio-video or navigation system provided on a vehicle is actually duplicated with the smart phone, but many of them cannot be used together. Until now, some car manufacturers take the link to the I-Pod of Apple as the standard equipment or selected equipment, and others use the USB (Universal Serial Bus) 2.0 (or Mini USB) to connect with the MP3 (only being provided with the audio MPEG-1 (Motion Picture Experts Group 1)) player. However, all these are limited to entertainment.

Some cars now are equipped with a Bluetooth device to connect with the cell phone, with that a contact book or text message on a cell phone can be even displayed on a screen of equipment in the car.

However, the largest shortcomings of the abovementioned conventional vehicle information unification structure are that
1. The vehicle is only limited to linking with the cell phone for the call function, therefore, the practicability is restricted.
2. The audio-video entertainment system in the vehicle cannot be controlled by a cell phone.
3. The two-way communication between the vehicle and the cell phone is limited. In terms of the function of controlling a cell phone by the vehicle, it is only limited now to an operation related to call, e.g., searching for an address book in the cell phone, browsing a call record of the cell phone or dialing a telephone number. For other programs in the cell phone, such as a game program, a navigation program, a calendar, a voice recording program or a video recording program, they are currently not able to be operated from a vehicle end.
4. After the vehicle has been connected with the cell phone, it is unable to utilize sufficiently an existing application program in the cell phone and hence, it is unable to provide more versatile additive functions to the vehicle.

Although for the abovementioned conventional vehicle information unification structure, the fundamental requirements and effects in terms of the display of vehicle information and integration of application can be achieved, the user's active convenience, the system integration and convenience, as well as the safety in using the data are all existing with many shortcomings and insufficiency in practical application, which is unable to develop more specific business applicability.

### SUMMARY OF THE INVENTION

The primary object of the present invention is to solve the issue that the display type of the conventional vehicle digital information cannot change with persons and the issue that the use of the conventional vehicle digital information cannot be versatile, user friendly, convenient and safe.

The present invention discloses a vehicle information unification method which combines with a hand-held electronic device, including step 1 that at least one hand-held electronic device is provided with a first processor, a first screen, a first transmission interface and a storage unit; step 2 that a vehicle is provided with a receiving system which contains a second processor, a second screen and a second transmission interface corresponding with the abovementioned first transmission interface; step 3 that the hand-held electronic device and the receiving system are interconnected within an effective distance through the first transmission interface and the second transmission interface, allowing the receiving system to access digital messages in the storage unit of the hand-held electronic device; and step 4 that the digital messages of step 3 are computed through the second processor in the receiving system and then a result of computation is outputted for use by the vehicle.

The abovementioned vehicle information unification method which combines with a hand-held electronic device further includes step 5 that the interconnection between the hand-held electronic device and the receiving system is ended beyond an effective distance and the receiving system does not store the digital messages in the hand-held electronic device.

In the abovementioned vehicle information unification method which combines with a hand-held electronic device, the receiving system provided on the vehicle is an audio-video system.

In the abovementioned vehicle information unification method which combines with a hand-held electronic device, the hand-held electronic device is chosen from a cell phone, a PDA (Personal Digital Assistant), a laptop computer, a tablet personal computer or a digital audio-video player.

In the abovementioned vehicle information unification method which combines with a hand-held electronic device, the first transmission interface and the second transmission interface are one of a USB cable, a Bluetooth device, an infrared device, an RF (Radio Frequency) device, a Wi-Fi device and a Zigbee device.

In the abovementioned vehicle information unification method which combines with a hand-held electronic device, the hand-held electronic device is provided with a chip slot for insertion with a chip key, allowing the hand-held electronic device to control start-up of the vehicle within an effective distance. In addition, the chip key further includes a near-field communication module and an RFID (Radio Frequency Identification Device) module.

In the abovementioned vehicle information unification method which combines with a hand-held electronic device, the hand-held electronic device is built in with an electronic payment unit to carry out an electronic payment when the vehicle is connected with the hand-held electronic device. The electronic payment unit utilizes one of the following payment tools: an ETC (Electronic Toll Collection) stored value card, an electronic wallet or a credit card.

In the abovementioned vehicle information unification method which combines with a hand-held electronic device, the hand-held electronic device is combined with an ETC unit.

In the abovementioned vehicle information unification method which combines with a hand-held electronic device, a result of computation outputted in step 4 for use by the vehicle refers to outputting a data displayed by an application software in the hand-held electronic device, such as an audio-video data, a navigation data, a GPS (Global Positioning System) real-time satellite positioning data, a contact data, a call record, a digital photograph, a film data, a note, an e-mail data, a text message or a web address.

In the abovementioned vehicle information unification method which combines with a hand-held electronic device, after the hand-held electronic device has been interconnected with the receiving system within an effective distance through the first transmission interface and the second transmission interface, the hand-held electronic device utilizes computation of the first processor to control the receiving system of the vehicle, whereas the receiving system utilizes computation of the second processor to control the hand-held electronic device.

The effects of the present invention are that
1. A single vehicle can be connected and matched with plural hand-held electronic devices. For different drivers or passengers, the vehicle can provide a complete personalized message and a personalized function in a time period of connection, allowing each driver or passenger to acquire more user-friendly and convenient vehicle operation environment when driving or riding the vehicle.
2. The vehicle and the hand-held electronic device can be connected quickly and the vehicle can access and apply the personalized data in the hand-held electronic device within an extremely short time after the two have been connected, which is extremely convenient.
3. As the personalized digital data and the application software are all stored in the hand-held electronic device, when the connection between the vehicle and the hand-held electronic device is ended, all the personalized digital data and the application software will be separated from the vehicle along with the hand-held electronic device. Therefore, users of the vehicle can only use their own personalized digital data (from their own hand-held electronic device) and will not be able to access other person's personalized digital data, which is highly safe.
4. By utilizing the hand-held electronic device to combine with a keyless chip key, the hand-held electronic device becomes a device to control opening doors of and starting up the vehicle. If the hand-held electronic device is a touch-type PDA, then required operation buttons can be designed on a screen of PDA.
5. The combination of the keyless system with RFID can improve significantly a transmission capability of the communication system and reduce a loss from interruption.
6. As the hand-held electronic device is built in or combined with the electronic payment unit, a payment tool, such as an ETC stored value card, an electronic wallet or a credit card, can be used, allowing the vehicle to be equipped with the function of electronic payment. In addition, the electronic payment function will depend upon the type of hand-held electronic device to be connected.
7. The ETC unit can be provided on-board or be built into the hand-held electronic device to carry out an ETC deduction, in association with an ETC stored value card or other electronic stored value card which is provided with an ETC deduction function.
8. After the vehicle has been connected with the hand-held electronic device, the navigation data in the hand-held electronic device can be accessed and displayed to carry out personalized navigation.
9. The hand-held electronic device and the vehicle can be connected with a wire or wirelessly, such as through a Bluetooth device or a USB interface which is provided with both a transmission function and a charging function.
10. After the hand-held electronic device has been connected with the vehicle, an on-board audio-video system can be operated through the hand-held electronic device. Therefore, even a back seat passenger is also able to operate on-board entertainment information conveniently.
11. All the hand-held electronic device functions, such as a communication function, music, a navigation data, a GPS real-time satellite positioning data, a contact data, a call record, a digital photograph, a film data, a note data, a voice recording function, a video recording function or a game program, can be used in an on-board audio-video system through connection, allowing the vehicle to become a personalized center of information and entertainment.
12. The navigation information on the hand-held electronic device can be displayed and operated on an on-board audio-video system through a transmission interface, such as a USB device or a Bluetooth device, which is provided with better visual and information effects.
13. The application software of the hand-held electronic device can be operated by a touch screen in an on-board audio-video system and a larger screen and better audio-video equipment in the vehicle can provide a better display platform for the application software in the hand-held electronic device, such as an MP3 player, a film player, a game program, an internet browsing program or an e-mail program.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a flow diagram of steps of the present invention.

FIG. 2 shows a schematic view of a linking structure of a hand-held electronic device with a vehicle receiving system, according to the present invention.

FIG. 3 shows a schematic view of using a keyless system, according to the present invention.

FIG. 4 shows a schematic view of using an electronic payment unit, according to the present invention.

FIG. 5 shows a schematic view of an operation of a hand-held electronic device which combines with an ETC unit and an ETC stored value card, according to the present invention.

FIG. 6 shows a schematic view of an output result of the receiving system of the present invention.

### DETAILED DESCRIPTION OF THE PREFERRED EMBODIMENTS

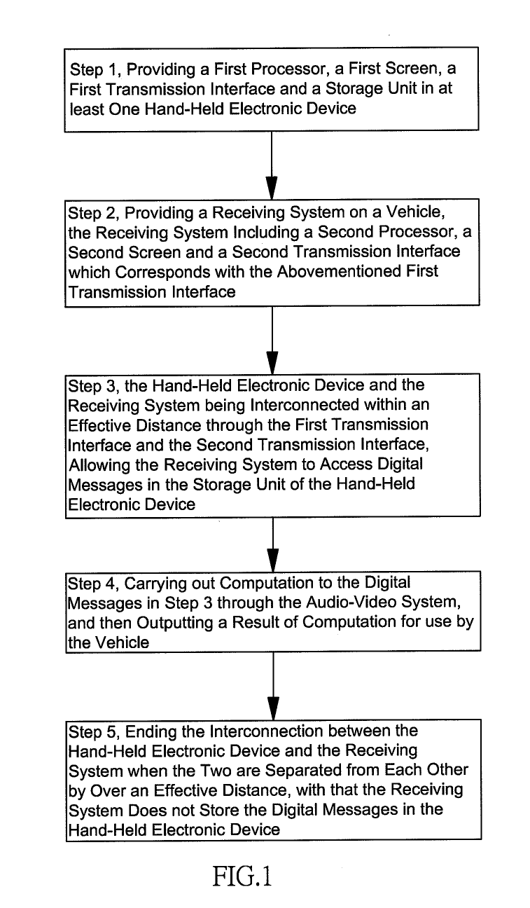

Referring to FIG. 1, the present invention discloses a vehicle information unification method which combines with a hand-held electronic device. The method includes:

Step 1, providing a first processor, a first screen, a first transmission interface and a storage unit in at least one hand-held electronic device;

Step 2, providing a receiving system on a vehicle, the receiving system being equipped with a second processor, a second screen and a second transmission interface which corresponds with the abovementioned first transmission interface;

Step 3, the hand-held electronic device and the receiving system being interconnected within an effective distance through the first transmission interface and the second transmission interface, allowing the receiving system to access digital information in the storage unit of the hand-held electronic device;

Step 4, carrying out computation to the digital information in step 3 through the second processor of the receiving system, and then outputting a result of computation for use by the vehicle; and

Step 5, ending the interconnection between the hand-held electronic device and the receiving system when the two are separated from each other by over an effective distance, and the receiving system not storing the digital information in the hand-held electronic device.

The abovementioned hand-held electronic device can combine with the following systems:

A. A Keyless System

The hand-held electronic device is provided with a chip slot for insertion with a chip key which is correspondingly connected to a keyless system provided by the vehicle through the first transmission interface and the second transmission interface of the vehicle, thereby allowing the hand-held electronic device to start up the vehicle. The keyless system further includes a near-field communication module and an RFID module.

B. An Electronic Payment Unit

The hand-held electronic device is correspondingly connected to the vehicle through the first transmission interface and the second transmission interface of the vehicle, allowing the vehicle to be equipped with an electronic payment function after connection. The electronic payment unit, on the other hand, can be an ETC stored value card for high way tolling, an electronic wallet into which a value can be added and from which a small bill can be paid, the EasyCard which is used in riding a public transportation vehicle or a credit card.

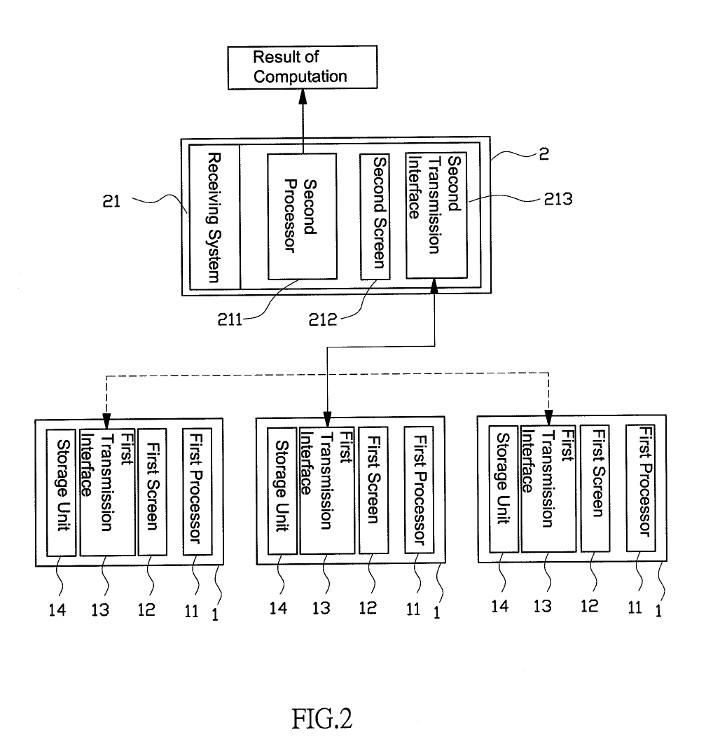

Referring to FIG. 2, the vehicle unification method of the present invention combines primarily with at least one hand-held electronic device 1. A first screen 12, a first transmission interface 13 and a storage unit 14 of the hand-held electronic device 1 are all electrically connected with a first processor 11; whereas, a receiving system 21 of a vehicle 2 is an audio-video system. The receiving system 21 includes a second processor 211, a second screen 212 and a second transmission interface 213 which corresponds with the first transmission interface 13.

In the present embodiment, the hand-held electronic device 1 is correspondingly connected with the second transmission interface 213 of the vehicle 2 within an effective distance through the first transmission interface 13, thereby allowing the receiving system 21 of the vehicle 2 to control a multimedia data in the hand-held electronic device 1 through computation of the second processor 211. In addition, the receiving system 21 of the vehicle 2 can be also controlled by the hand-held electronic device 1 through computation of the first processor 11.

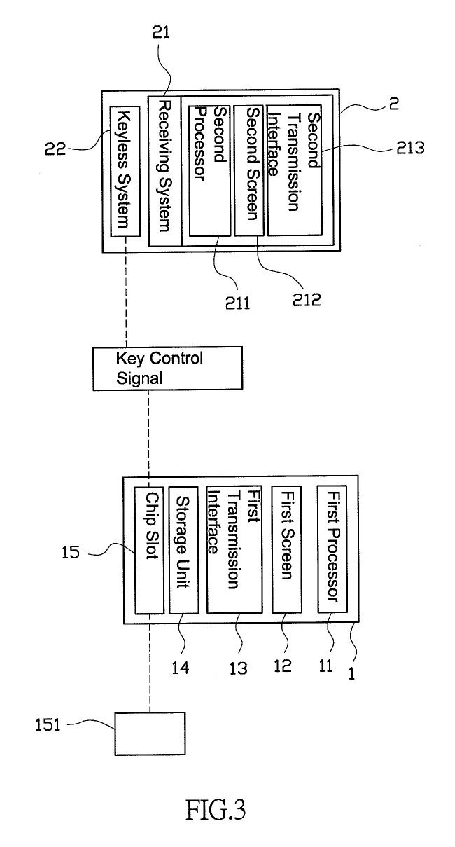

Referring to FIG. 3, in terms of the keyless system 22, the hand-held electronic device 1 is provided with a chip slot 15 into which is inserted a chip key 151 to connect correspondingly to the keyless system 22 of the vehicle 2. Accordingly, the hand-held electronic device 1 can emit a key control signal to the keyless system 22 to carry out operations of opening door locks of the vehicle, setting or removing an alarm system of the vehicle, and starting up an engine of the vehicle. The keyless system 22 includes a near-field communication module and an RFID module.

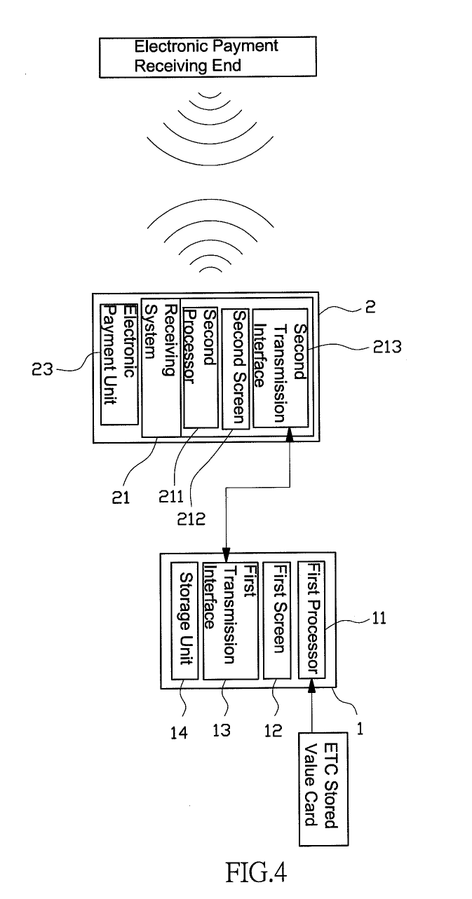

Referring to FIG. 4, in terms of the electronic payment unit 23, the hand-held electronic device 1 is correspondingly connected to the vehicle 2 with the first transmission interface 13 and the second transmission interface 213 of the vehicle 2. The electronic payment unit 23 can at least utilize the following payment tools: an ETC stored value card used in high way tolling, an electronic wallet into which a value can be added and from which a small bill can be paid, and the EasyCard that can be used in riding a public transportation vehicle. In the embodiment of FIG. 4, the electronic payment unit 23 of the vehicle 2 is an ETC unit, whereas the hand-held electronic device 1 is connected with an ETC stored value card or other electronic stored value card that is provided with an ETC deduction function.

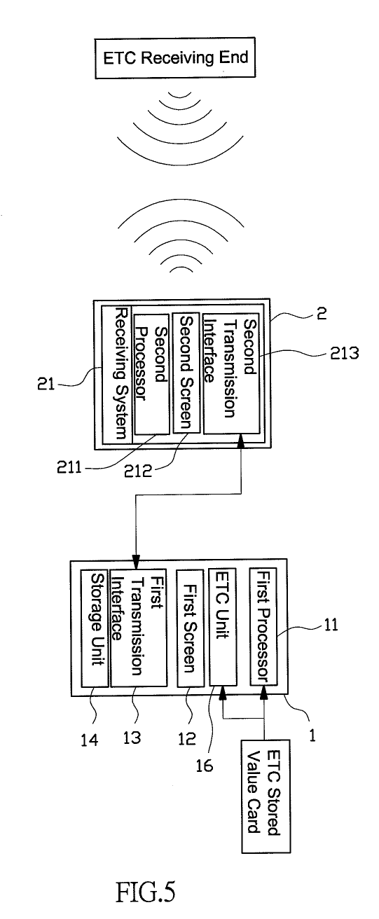

Referring to FIG. 5, for the vehicle 2 that is not installed with an ETC unit, the hand-held electronic device 1 of the present invention can be also built in or added with an ETC unit 16. When the hand-held electronic device 1 is connected with another ETC stored value card or other electronic stored value card that is provided with the ETC deduction function, the hand-held electronic device 1 will be correspondingly connected to the second transmission interface 213 of the vehicle 2 with the first transmission interface 13, allowing the vehicle 2 to be equipped with the ETC payment function.

When the hand-held electronic device 1 is located away from the vehicle 2 by exceeding an effective distance, the connection between the hand-held electronic device 1 and the vehicle 2 will be ended automatically. After the connection has been ended, the vehicle will not store the important data in the hand-held electronic device 1 to assure the safety of personal data.

The vehicle 2 can make connection with plural hand-held electronic devices 1 and any driver or passenger who holds the hand-held electronic device 1 can use that hand-held electronic device 1 to make connection with the vehicle 2, allowing the vehicle 2 to become a personalized center of information and entertainment.

When plural hand-held electronic devices 1 that have made connection are within an effective distance of connection to the vehicle 2 at a same time, the vehicle can choose to make a prioritized connection with any one of the hand-held electronic devices 1.

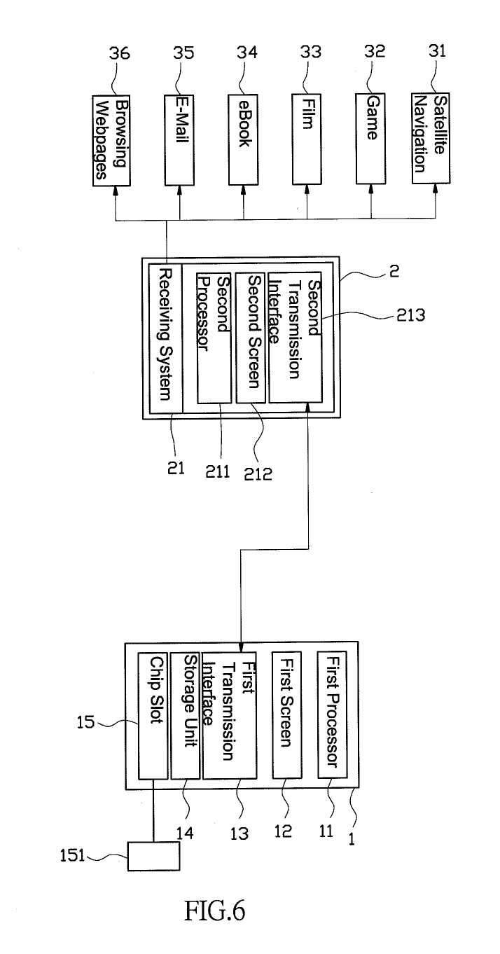

Through the present invention, the vehicle 2 is only needed to be provided with a basic receiving device and control interface (such as a touch screen) that the vehicle 2 can connect with the corresponding hand-held electronic device 1 at any time, thereby controlling and utilizing multiple additive functions of that hand-held electronic device 1. In addition to communication, these functions also include an electronic key, an electronic payment, satellite navigation, real-time satellite positioning, sending and receiving an e-mail, internet browsing, sending and receiving a text message, listing to music, watching a film, reading an eBook, searching for a contact data, searching for a call record, watching a digital photograph, checking a note and playing a game program, allowing the vehicle 2 to be provided with enriched auxiliary information, greatly improving comfortableness and convenience of the vehicle and allowing the application programs of the hand-held electronic device 1 to have a better display platform through the audio-video equipment of the vehicle. For example, as shown in FIG. 6, the application programs in the hand-held electronic device 1 are transmitted to the second transmission interface 213 of the vehicle 2 through the first transmission interface 13 of the hand-held electronic device 1. Next, through computation of the second processor 211, the receiving system 21 outputs results of satellite navigation 31, a game program 32, a film 33, an eBook 34, an e-mail 35 and webpage browsing 36 for use by the vehicle 2, thereby greatly improving the convenience in utilizing the vehicle 2. However, the abovementioned output results are only part of feasible examples of the present invention, other output results of the hand-held electronic device 1 also include an audio-video data, a GPS real-time satellite positioning data, a contact data, a call record, a digital photograph, a film data, a note, a text message and a web address.

The abovementioned hand-held electronic device 1 is chosen from the following: a cell phone, a PDA, a laptop computer, a tablet personal computer and an audio-video player.

The first transmission interface 13 and the second transmission interface 213 described above are any one of the following: a USB cable, a Bluetooth device, an infrared device, an RF device, a Wi-Fi device and a Zigbee device.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A vehicle information unification method which combines with a hand-held electronic device, comprising steps of:
1) providing a first processor, a first screen, a first transmission interface and a storage unit in at least one hand-held electronic device;
2) providing a receiving system on a vehicle, the receiving system including a second processor, a second screen and a second transmission interface which corresponds with the first transmission interface of the hand-held electronic device;
3) the hand-held electronic device and the receiving system being interconnected within an effective distance through the first transmission interface and the second transmission interface, allowing the receiving system to access digital messages in the storage unit of the hand-held electronic device; and
4) carrying out computation to the digital messages in step 3 through the second processor of the receiving system, and then outputting a result of computation for use by the vehicle.

2. The vehicle information unification method which combines with a hand-held electronic device, according to claim 1, further comprising a step of: 5) ending the interconnection between the hand-held electronic device and the receiving system when the two are separated from each other by over an effective distance, with that the receiving system does not store the digital messages in the hand-held electronic device.

3. The vehicle information unification method which combines with a hand-held electronic device, according to claim 1, wherein the receiving system provided on the vehicle is an audio-video system.

4. The vehicle information unification method which combines with a hand-held electronic device, according to claim 1, wherein the hand-held device is chosen from a cell phone, a PDA (Personal Digital Assistant), a laptop computer, a tablet personal computer and a digital audio-video player.

5. The vehicle information unification method which combines with a hand-held electronic device, according to claim 1, wherein the first transmission interface and the second transmission interface are a USB (Universal Serial Bus) cable, a Bluetooth device, an infrared device, an RF (Radio Frequency) device, a Wi-Fi device or a Zigbee device.

6. The vehicle information unification method which combines with a hand-held electronic device, according to claim 1, wherein the hand-held device is further provided with a chip slot for insertion with a chip key, allowing the hand-held device to control start-up of the vehicle within an effective distance.

7. The vehicle information unification method which combines with a hand-held electronic device, according to claim 6, wherein the chip key further includes a near-field communication module and a radio frequency module.

8. The vehicle information unification method which combines with a hand-held electronic device, according to claim 1, wherein the hand-held device is built in with an electronic payment unit, allowing an electronic payment to be carried out when the vehicle is connected with the hand-held electronic device.

9. The vehicle information unification method which combines with a hand-held electronic device, according to claim 8, wherein the electronic payment unit utilizes one of the following tools: an ETC (Electronic Toll Collection) stored value card, an electronic wallet or a credit card.

10. The vehicle information unification method which combines with a hand-held electronic device, according to claim 1, wherein the hand-held electronic device is combined with an ETC unit.

11. The vehicle information unification method which combines with a hand-held electronic device, according to claim 1, wherein a result of computation outputted in the step 4 provides for use by the vehicle refers to the data displayed by an application software in the hand-held electronic device.

12. The vehicle information unification method which combines with a hand-held electronic device, according to claim 11, wherein the data that is displayed by the application software in the hand-held electronic device includes an audio-video data, a navigation data, a GPS (Global Positioning System) real-time satellite positioning data, a contact data, a call record, a digital photograph, a film data, a note, an e-mail, a text message or a web address.

13. The vehicle information unification method which combines with a hand-held electronic device, according to claim 1, wherein after the hand-held electronic device and the receiving system have been interconnected within an effective distance through the first transmission interface and the second transmission interface, the hand-held electronic device utilizes computation of the first processor to control the receiving system of the vehicle, whereas the receiving system utilizes computation of the second processor to control the hand-held electronic device.
